(19) United States
(12) Patent Application Publication
(10) Pub. No.: US 2017/0294239 A1
(43) Pub. Date: Oct. 12, 2017

(54) FUSION NEUTRON-SOURCE POWER SYSTEM

(71) Applicant: Saade Youssef Makhlouf, Beirut (LB)

(72) Inventor: Saade Youssef Makhlouf, Beirut (LB)

(21) Appl. No.: 15/047,762

(22) Filed: Feb. 19, 2016

Related U.S. Application Data
(60) Provisional application No. 62/118,470, filed on Feb. 20, 2015.

(51) Int. Cl. G21B 1/05; G21B 1/11

(52) U.S. Cl. CPC G21B 1/05; G21B 1/11; G21Y 2002/104; G21Y 2002/20; G21Y 2002/201; G21Y 2004/30

(57) ABSTRACT

The fusion reactor of the invention comprises a plurality of elongated triangular electrodes aligned in a cylindrical shape to form an axially symmetric containment geometry. The electrodes are separated by means of electrical insulator preferably pure swept Quartz (SiO2). The Triangular electrodes, are made out of very high electro conductive, high strength, heat resistant, radiation resistant and neutrons moderating material such as thorium carbide, uranium carbide or silicon carbide or the like which is preferably made by ceramic powder metallurgy process. Each electrode includes a cooling structure or flow channel formed in the internal structure allowing for a cooling fluid for extracting heat caused by plasma and nuclear reactions. The acceleration channels electrodes of the fusion reactor are of triangular shape and are protected with a continuously changing protective film or layer of high electro-conductive fissile or fertile material such as thorium carbide or uranium carbide. Lithium may be added for the reactor to breed its own Tritium.

### CROSS REFERENCE TO RELATED APPLICATIONS

This application claims the benefit of U.S. Provisional Application No. 62/118,470, filed Feb. 20, 2015, a copy of which is incorporated herein by reference and relied upon.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

This invention relates to the field of thermonuclear reactors for producing safe and controlled nuclear power. More specifically this invention is related to a fusion neutron-source power system which may be assisted by other inputs for producing useful energy.

Nuclear Energy is generally produced whenever a light nucleus is undergoing fusion or whenever a heavy nucleus is undergoing fission. Practical examples are natural Uranium or Thorium (fission) and Deuterium, Tritium, Lithium (fusion) both adequate for many thousands of years at several times the present energy consumption.

There is growing interest in using nuclear fusion for generating electricity in the future. The fuel it would use is abundant and it produces no greenhouse gases.

The fusion of one kilogram of D-T fuel releases thousands of times more energy than burning one kilogram of coal and has no associated greenhouse gas emissions. The fuel supply is abundant—deuterium occurs naturally in seawater and tritium could be ‘bred’ within a fusion reactor, from lithium.

Sustaining fusion under laboratory conditions presents many technological challenges. For D-T fusion to occur, the fuel must be heated to ˜100 million ° C. At such temperatures, the fuel transforms into a gaseous plasma of nuclei and electrons. This hot plasma must be confined to avoid damaging its containment vessel. Currently the most advanced confinement technique is magnetic confinement, where magnetic fields suspend the plasma within a large containment vessel. The most common apparatus is the tokamak—a doughnut (torus) shaped magnetic chamber.

In this torus-type nuclear fusion reactor, there is disposed a ring-like vacuum vessel for confining plasma therein. The vacuum vessel is surrounded by toroidal magnetic field coils which produce a magnetic field which heats the plasma and keeps it in a confined space. However, fast neutrons of 14 Mev irradiate the vacuum vessel and deteriorate it.

Large amounts of energy are needed to maintain the high temperatures required for fusion. However, if the energy generated from fusion were to exceed the amount put in, there would obviously be a net energy output. The ultimate aim of fusion research is to harness this energy to meet future energy demands. To gauge the performance of fusion experiments, three conditions can be defined: breakeven, ‘burning’ plasma and ignition. Of these, only breakeven has been demonstrated to date.

Current fusion reactors are very large, cost billions of dollars and face numerous technological difficulties such as limited magnetic field strength, energy loss from plasma instabilities, heat losses and particle drift across the magnetic fields among other difficulties, most of these technical challenges come from the design of the reactors.

There are some really difficult engineering problems with current designs of fusion reactors that have not been overcome despite forty years of concerted effort and well over $20 billion spent on the research.

The issues include the potentially prohibitive constructions costs, and the difficulties of repairing and maintaining the reaction vessel. The massive “blanket” of lithium and rare metals—that must surround the fusion-generating plasma in order to absorb its emitted neutrons—will degrade and become radioactive over time, requiring regular dismantling and replacement.

What is needed is a revolution in fusion design. Still further, what is needed is a design that offers a very efficient and compact fusion reactor which can be built in a relatively short period of time and cost much less while concurrently providing a viable approach to controlled fusion energy by allowing the construction of a relatively simple and compact, pulsed fusion reactor.

### SUMMARY OF THE INVENTION

The fusion reactor of the invention comprises a plurality of elongated triangular electrodes aligned in a cylindrical shape to form an axially symmetric containment geometry. The electrodes are separated by means of electrical insulator such as pure swept Quartz (SiO2). The Triangular electrodes, are made out of very high electro conductive, high strength, heat resistant, radiation resistant and neutron moderating material such as thorium carbide, uranium carbide or silicon carbide or the like which is preferably made by ceramic powder metallurgy process. Each electrode includes a cooling structure or flow channel formed as an internal structure allowing for a cooling fluid for extracting heat caused by plasma and nuclear reactions. The acceleration channel electrodes of the fusion reactor are of triangular shape and are protected with a continuously changing protective film or layer of high electro-conductive fissile or fertile material such as thorium carbide or uranium carbide. Lithium may be added for the reactor to breed its own Tritium.

In an embodiment, the invention is made up of multiple channels (four channels or more) of high density pulsed plasma generators that produces high temperature plasma.

In an embodiment, the high density pulsed plasma generator electrodes are insulated by means of transparent and very pure Quartz (SiO2) especially when the fusion reactor is assisted by a high density pulse CO2 laser.

Although the present invention provides a fusion reactor which may be assisted by a laser, but it should be noted that this fusion reactor of the invention can also produce an efficient energy yield without being assisted with a laser.

An advantage of this fusion reactor is that the plasma is compressed by its own magnetic field created by the plasma gun; therefore there will be no need to confine it by creating a magnetic field using external magnets.

Another advantage of this design is that it provides a shape of the electrodes facilitating the applying of a protective film.

Another advantage is that it provides a design that facilitates the cooling of the structure and the harnessing of heat generated by the nuclear reactions.

Another advantage of the invention is that it makes it possible to build compact fusion reactors offering a safe and controlled On-Off nuclear power. It radiates, briefly albeit intensely, only when it is operating. This is a great advantage compared with isotope sources which continually radiate even during its off-use time, hence requiring careful storage and expensive storage facilities.

It is well known that due to the scalability of the plasma phenomena, the energy density of the focused plasma is a constant over the whole range of plasma focus generators despite the size of the machine; consequently, a small plasma focus machine, when tuned for optimal operation, produces the same plasma characteristics in terms of temperature and energy density as a big machine, however this unique design provides multiple plasma generators aligned in a cylindrical form ejecting plasma from all sides to the center of the reactor which increase the generated plasma volume, consequently they generate a plasma of a longer life and which yields more neutrons.

Unlike the current fusion reactors, this invention provides a fusion reactor that can be built in a relatively short period of time and which cost much less while ensuring a stable operation combined with high efficiency to make electricity production economic.

In another advantage, the design provides a fusion reactor with a structure having a continuously changing protective film capable of protecting the reactor structure from neutron damage while maintaining the current and heats the plasma to produce neutrons with minimal power input.

In another advantage, the invention produces a large plasma volume, strong magnetic field without external magnets and high plasma temperature to provide high density hot stable plasma so that the nuclei fuse together releasing the fast neutrons and associated energy.

In another advantage, the mass implementation of this reactor can respond to the urgent needs for power anywhere on the globe because no critical, difficult, or costly developments are required.

### BRIEF DESCRIPTION OF THE DRAWINGS

FIG. 1 a perspective view of a fusion reactor electrode of the invention.

FIG. 2 a cross-sectional view of the fusion reactor of the invention.

FIG. 3 a cross-sectional view of fusion reactor having a protective film device and assisted by a laser.

FIG. 4 a perspective view of the structure of the fusion reactor of the invention.

Those skilled in the art will appreciate that elements in the figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as they are exemplary in nature, serving to describe the best mode of the invention known the inventors as of the filing date hereof. Consequently, changes may be made in the arrangement and/or function of any of the elements described in the exemplary embodiments disclosed herein without departing from the spirit and scope of the invention.

The fusion reactor of this invention consists of a plurality of triangular elongated electrodes aligned in a cylindrical shape to form an axially symmetric containment geometry wherein said electrodes are separated by means of a wall of pure Quartz (SiO2). The Triangular electrodes, made out of very high electro conductive, high strength, heat resistant, radiation resistant and neutron moderating material such as thorium carbide, uranium carbide or silicon carbide or the like are preferably made by ceramic powder metallurgy process. The electrodes include a cooling structure or flow channel formed as an internal structure allowing for a cooling fluid for extracting heat caused by plasma and nuclear reactions. This cooling structure is essentially an efficient heavy or light water cooling jacket extending along the electrodes of the acceleration channel. Lithium may be used as an efficient coolant which breeds tritium to be used as fuel for the reactor.

The electrodes of the acceleration channels of the fusion reactor have a triangular pie shape and are protected with a continuously changing protective film or layer of high electro-conductive and neutrons moderating material such as thorium carbide or uranium carbide. The protective film may contain Lithium for the purpose of breeding tritium where ⁶Li+n=T+⁴He+4.6 Mev.

The protective film may be in the form of film or sheets or the like, extending along and bounding the acceleration channel to form a protective casing surrounding the surface area of the plasma generator electrodes.

The protective films are wound on reels or the like for which the speed is synchronized with the pulse frequency of the plasma gun and the laser so as to feed continuously and in controlled manner.

The protective film protects the electrodes against thermal and particles loads as well as from the application of electromagnetic forces produced during operation of the fusion reactor. It is important to consider that the moving protective film also constitutes the neutron absorbing blanket which may contain fissile fuel such as uranium or thorium.

Further, the structural design of this fusion reactor facilitates the application and movement of the protective film.

The Plasma generator electrodes of this fusion reactor are preferably separated by pure and transparent Quartz (SiO2) which transmits the laser energy very effectively and has excellent dielectric and thermal resistance properties. Additionally, Quartz has a relatively high hardness and good machining characteristics as well as durability of the working surfaces during operation. Further, Quartz enjoys a low thermal coefficient of linear expansion and good dielectric properties in wide temperature range and frequency bands as well as in strong electrical fields. Furthermore, Quartz enjoys high stability when subjected to intensive laser radiation including UV.

The design of the invention provides an effective cooling structure for both the electrodes and the insulating Quartz by means of a coolant such as water for the electrodes and preferably distilled water or pure liquid CO2 for the Quartz.

CO2 lasers may be used without reservation in the fusion reactor of the invention. Such lasers are among the most efficient and powerful of all lasers, and have many applications in industrial, military and medical fields.

The plasma sheath is an ideal or perfect mirror which reflects the laser beam and therefore it may be used as the laser's second mirror. This is one of the invention advantages because the laser may only have one 100% mirror.

Laser photons hit the plasma sheath, which is an ideal blackbody, and are reflected in the opposite direction at the angle of incident giving its mechanical propulsion P energy to the ions based on the following equation:

P=1,927*10⁻²¹T⁴ kg/cm²

The mechanical propulsion on the ideal blackbody at T=100,000° C. is about 0.2 kg/cm2 where it is about 2000 kg/cm² at 1,000,000° C. which equal to 20,000 tone/m².

The laser assisted fusion reactor is a device that utilizes the interaction of ultrahigh energy intensity pulsed laser beam of the proper frequency with a current sheath created by a plasma gun. A high intensity current flows through the electrodes of the acceleration channels forming a plasma sheath between each two electrodes of the fusion reactor near the insulator. It is initially formed here because the distance between the two electrodes is slightly smaller near the insulator. The current sheath will become like a mirror propagating between the electrodes. The speed of the current sheath, the length of the tube and the rise time of the capacitor discharge are matched so that the current sheath reaches the end of the electrodes just as the discharge reaches its quarter cycle. The discharge becomes more intense as the sheath propagates. The laser is synchronized to fire on the current sheath as it propagates between the electrodes of the acceleration channels. The current sheath is driven by the magnetic pressure of its own magnetic field (Lorentz force) and accelerated by the laser beam. The laser accelerates ions to a speed equal to about 10% of light speed in a very short geometrical distance. Sheaths ejected from the symmetric acceleration channels travel to and are confined at the center of the reactor producing enormous quantity of energy in a controlled manner.

The current sheath acts as a magnetic piston, creating a strong shock wave in the internal pre-ionized gas due to the motion of the current, thereby compressing and heating the fuel at the center of the reactor so much that fusion reactions occur. The analogy to the classical snowplow is very well applicable to the acceleration channels, because the pre-ionization of gas and collisions between particles are important. The fusion rate in the region is highly compressed by the strong shock wave which can give off significant amounts of highly energetic alpha particles where their energy is transformed into thermal energy due to the high density of the fuel. This additional energy will cause additional fusion reactions in the heated fuel, giving off more high-energy particles. Additionally, the very high compression ratios minimize the initial plasma energy.

When the current sheaths reach the end of the acceleration channels electrodes, they are ejected away from the electrodes toward the center of the fusion reactor whether the sheath continues to flow as an arc or exit freely. This produces the hot plasma volume where ion number density may be as high as 10²² cm⁻³, the high temperature plasma of over 10 Kev and the confining magnetic fields are of the order of 5 to 100 Tesla. At this time and for a period on the order of microseconds, neutrons are produced. Produced neutrons in this reactor are considered to be mainly of nuclear bombardment origin but it cannot be excluded that a part of neutrons (10-20%) comes from thermonuclear origin emitted by high temperature plasma.

To ignite the nuclear fusion, it is necessary to put together nuclei of specific light atoms close enough to overcome the strong repulsive electrostatic forces and confine them sufficiently long.

This reactor can achieve extremely high optimized pressure, several orders of magnitude higher than what other devices currently use. This high density of the operating gas may also contribute to the increase in the neutron yield as compared to other machines. The increase in the fuel gas density will definitely lead to the increase in neutron yield. In any case, there are certain advantages while operating in this extremely-high pressure regime: as high pressure operation will allow more reliable gas breakdown across the insulator compared to low pressure breakdown. In this way, the sensitive parts of the high voltage insulation are protected at high operating pressures, while the reproducibility is extremely good. The latter is extremely important while operating the device in repetitive mode, as a neutron source.

This fusion reactor running by electrical discharge on D-D/D-T/D-3He/H-T gases and assisted by laser allows for the production of bursts of up to 10²¹ neutrons/sec, producing energy output which may be several times the energy input, thus making this fusion reactor commercially viable while being relatively very low cost to manufacture, install and operate.

Thus it should be apparent that the invention provides a new design of fusion reactor which uses a series of plasma generators aligned with respect to each other in a cylindrical form to provide multiple focused acceleration channels which can be increased or decreased easily and where the number of such channels can reach 100 or more in a compact design, all of them injecting high density hot plasma toward the center of the reactor. Therefore, this design provides a fusion reactor where the three main parameters of plasma, temperature, density and confinement time are met to their maximum in a simple design.

In addition, for electrical power generation, there are many other applications that may effectively use fusion neutrons to create products or modify existing products, such as breeding fissile fuels for use in complementary fission plants or to produce energy in a subcritical fissionable blanket. This fusion reactor provides an important system to transmute fission nuclear wastes to stable elements or short-lived isotopes. It can also convert the huge stockpiles of depleted uranium into fresh fuel. Still further, it can be used to alter material properties and produce considerable quantities of precious elements.

The fusion reactor of the present invention provides a number of elongated triangular electrodes aligned in a cylindrical shape and separated by means of pure Quartz to form an acceleration channel or plasma generator between each two electrodes. Each electrode has either a positive or negative polarity and each electrode which has a positive polarity is located between two electrodes having negative polarity and vice-versa.

The Triangular electrodes, are made out of very high electro conductive, high strength, heat resistant, radiation resistant and neutron moderating material such as thorium carbide, uranium carbide or silicon carbide or the like which is preferably made by ceramic powder metallurgy process.

Each electrode includes a cooling structure or flow channel formed in the internal structure allowing for a cooling fluid for extracting heat caused by plasma and nuclear reactions. The cooling jacket extends along the acceleration channels electrodes. Lithium may be used as an efficient coolant while breeds tritium to be used as fuel for the reactor. A solution of liquid fuel such as uranium chloride may also be used.

The reactor electrodes are separated by mean of pure and transparent Quartz (SiO2). Vacuum-swept synthetic quartz is preferably used for this reactor. Swept Quartz has better characteristics as “radiation-resistant” than natural or cultured Quartz because it is grown in a highly controlled environment and has a higher degree of purity. This helps minimize the changes that occur in the electrical parameters of a crystal when it is exposed to radiation.

The acceleration channels electrodes of the fusion reactor have the shape of a triangle and are protected with a continuously changing protective film or layer of high electro-conductive fissile or fertile material such as Thorium or Uranium. It may also contain Lithium for the purpose of breeding tritium. The top ends of the electrodes have a shape allowing the protective film to slide and move smoothly without being cut.

The fusion reactor of the present invention compresses and accelerates the fuel gases by the magnetic field pressure of the discharge current supplying the plasma. The current sheath acts as a magnetic piston, creating a strong shock wave in the internal pre-ionized gas due to the motion of the current, therefore compressing and heating the fuel at the center of the reactor so much that fusion reactions occur.

The fusion reactor of the present invention may be assisted with a laser. The laser assisted fusion reactor utilizes the interaction of laser beams of the proper frequency with hot illuminating plasma sheaths, generated by plasma generators aligned in a cylindrical assembly, during their propagation between the plasma generators' electrodes. Although the plasma generators already accelerate the gas ions by Lorentz force, the kinetic energy of ions increases rapidly with the increasing the ions velocity if the ions velocity is raised above that obtainable by the plasma generator. Therefore, a high energy laser pulse may be used to accelerate the plasma sheath during its propagation between the plasma generator electrodes.

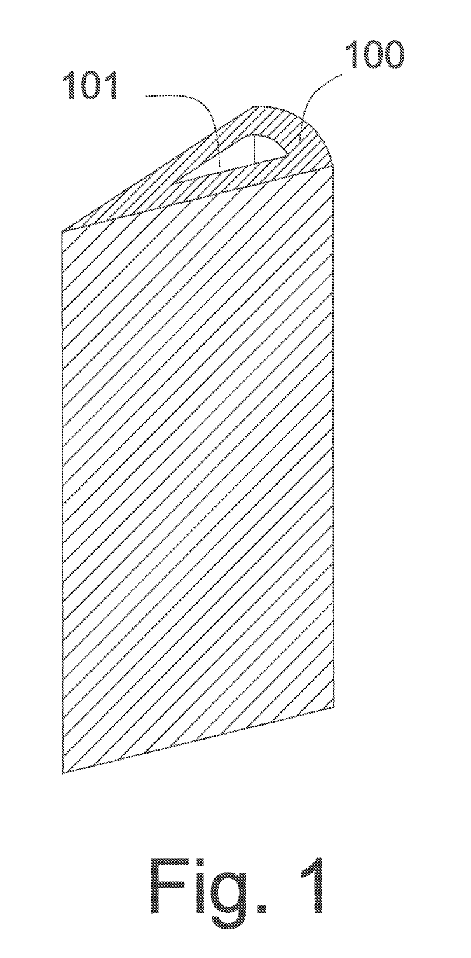

Referring to the figures, FIG. 1 shows an elongated triangular electrode 100 and a cooling flow channel 101. The top end of the triangular electrode have a semi-spherical shape to allow the protective film or fuel blanket to slide and move smoothly on the electrodes without being cut. The electrode could be made out of thorium carbide, uranium carbide, silicon carbide or the like by “ceramic powder metallurgy process”.

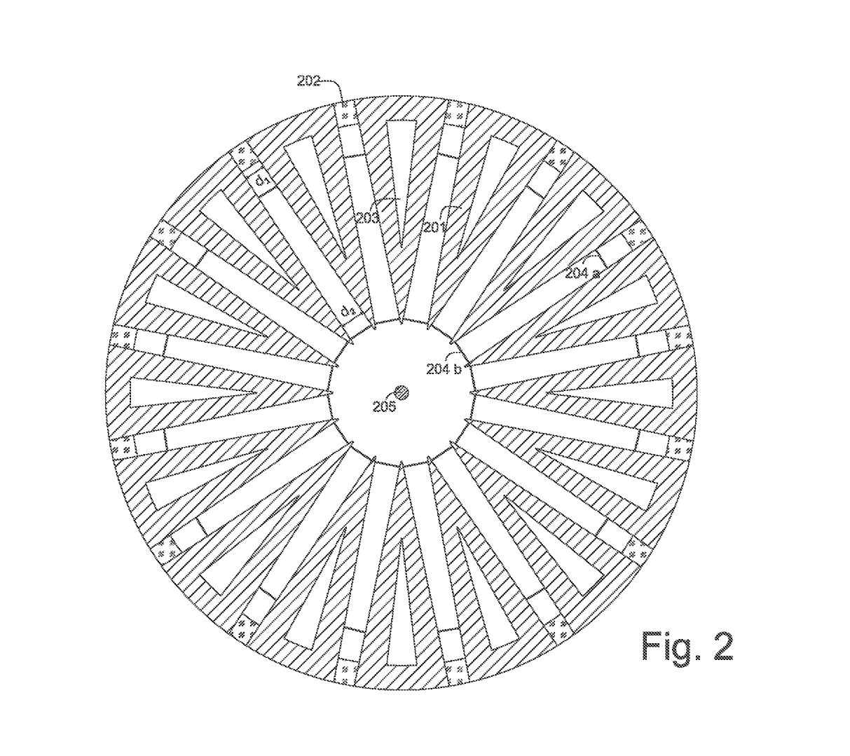

Referring to FIG. 2 the invention provides a sixteen acceleration channels fusion reactor. Before the sequence of events is started, both the high energy laser and the fusion reactor are filled to the desired pressures with the gases to be used; and the power supplies are charged to the working voltages. The sequence of events starts when the working voltages appear across the electrodes 201 of the fusion reactor. Because of the high intensity current, the gas in the acceleration channels 206 breaks down near the quartz insulator 202 forming the current sheath 204 a. The laser, which is disposed in axial alignment with each acceleration channel, is synchronized to fire on the current sheath which then propagates between two electrodes. The current sheath is driven by the 10o magnetic pressure of its own magnetic field and accelerated by the high energy laser beam to gain a kinetic energy of several MeV.

In a tokamak system of the prior art, external magnets are used to confine the plasma in the center of the containment vessel. However in the system of the invention, no external magnets are needed because the same force that creates the plasma confines it.

When the current sheaths 204 b reach the end of the acceleration channel electrodes, they are ejected away from the electrodes toward the center of the fusion reactor. This produces hot plasma volume 205 where ion number density may be as high as 10²² cm⁻³, and high temperature plasma of over 10 Kev and the confining magnetic fields are of the order of 5 to 100 Tesla. At this time and for a period on the order of microseconds, neutrons are produced. The neutrons produced in this reactor are considered to be mainly of nuclear bombardment origin but it cannot be excluded that a part of neutrons (10-20%) comes from thermonuclear origin emitted by high temperature plasma. Heat produced by the plasma and by the nuclear reactions in the sliding fuel blanket will be extracted by the coolant in the cooling flow channel 203.

The distance between two electrodes of the present invention is slightly smaller near the Quartz insulator where d1<d2 for the gas to break near the insulator.

Note that the electrical system, charging resistor, condenser bank, starting switch and pulse generator and other equipment like lasers, gas pumps and vacuum pumps are not shown but are familiar to someone of ordinary skill in the art.

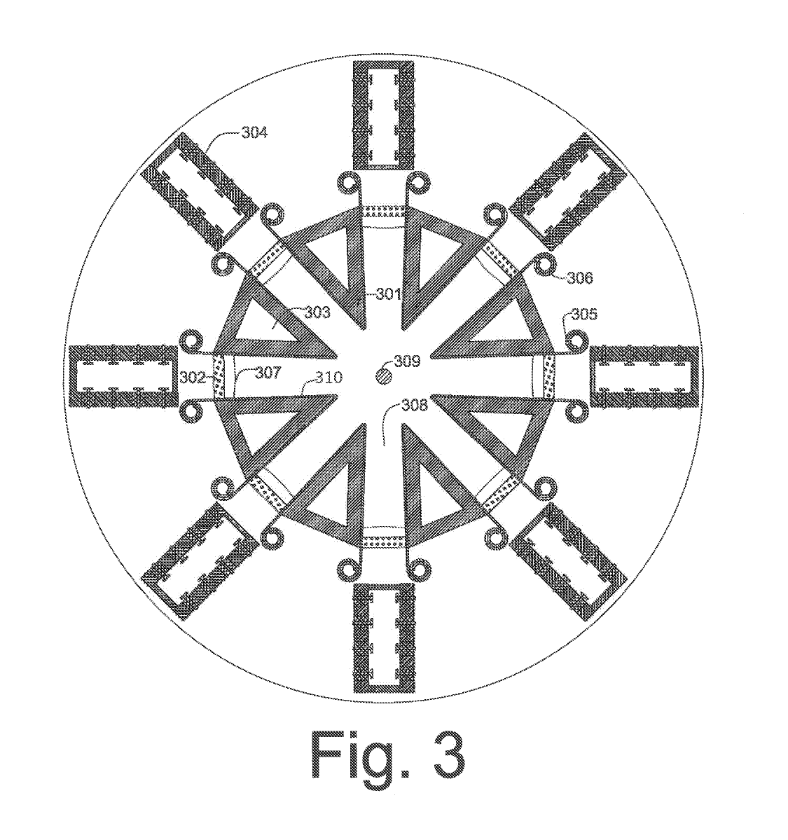

FIG. 3 provides an eight acceleration channels 308 fusion reactor wherein eight elongated triangular electrodes 301 are aligned in a cylindrical shape and separated by means of pure transparent Quartz 302 and wherein each electrode has an internal flow channel 303 for a coolant. A laser 304 disposed in axial alignment with each acceleration channel.

The acceleration channels electrodes 301 of the fusion reactor having a triangular shape are protected with a continuously changing protective film 310 of high electro-conductive and neutrons moderating material such as thorium carbide or uranium carbide. The protective film 310 extends along and bounds to the electrodes of the fusion reactor.

The protective films are wound on reels or likewise which speed is synchronized with the pulse frequency of the plasma gun and the laser to control continuously and in controlled synchronicity the feed means 305 and the winder means 306 of the protective layer.

A high intensity current flows through the electrodes of the acceleration channels where the gas breaks down near the quartz insulator 302 forming a plasma sheath 307 between each two electrodes of the fusion reactor. The discharge becomes more intense as the sheath 307 propagates. The laser 304 is synchronized to fire on the current sheath as it propagates between the electrodes 301 of the acceleration channels 308. The current sheath 307 is driven by the magnetic pressure of its own magnetic field (Lorentz force) and accelerated by the laser beam. Sheaths ejected from the symmetric acceleration channels toward the center of the fusion reactor confine to form the hot plasma 309. The hot plasma volume increases dramatically when the number of acceleration channels increases which enable this fusion reactor to produce hot plasma that can last relatively longer and produce more heat and neutrons per pulse. Neutrons produced by the plasma 309 hit the protective layer 310 which contains fertile material (Uranium or Thorium) causing a secondary nuclear fission reaction and producing more heat which will be absorbed by the coolant flowing in the flow channel 303.

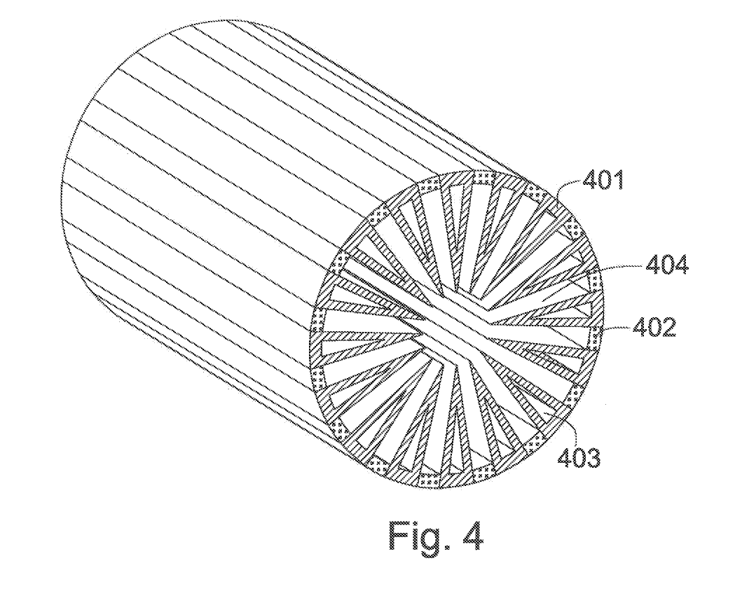

FIG. 4 shows a longitudinal view of a fusion reactor of FIG. 2, a number of elongated triangular electrodes 401 having a cooling structure 403 separated by means of 10o pure Quartz 402 are aligned in a cylindrical shape to form axially symmetric containment geometries wherein a plasma generator or acceleration channel 404 is formed between each two electrodes 401. Each electrode 401 has either a positive or negative polarity and wherein each electrode having a positive polarity is located between two electrodes having negative polarity and vice-versa. A high intensity current flows through the electrodes 401, the fuel gas breaks near the insulator 202 forming a current sheath which is driven by the magnetic pressure of its own magnetic field and accelerated toward the center of the fusion reactor where it is confined, producing the hot plasma.

It should be appreciated that the particular implementations shown and herein described are representative of the invention and its best mode and are not intended to limit the scope of the present invention in any way.

It should be appreciated that many applications of the present invention may be formulated. Moreover, the system contemplates the use, sale and/or distribution of any goods, services or information having similar functionality described herein.

As will be appreciated by skilled artisans, the present invention may be embodied as a system, a device, or a method.

Moreover, the system contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-à-vis the public or third parties, no express or implied license is granted to prepare derivative works based on this patent specification, inclusive of the appendix hereto and any computer program comprised therein.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

What is claimed is:

1. A fusion reactor comprising at least:
a. a plurality of elongated triangular electrodes made out of very high electro conductive, high strength, heat resistant, radiation resistant and neutrons moderating material such as thorium carbide, uranium carbide or silicon carbide or the like preferably made by ceramic powder metallurgy process, are aligned adjacent one another in a cylindrical shape to form axially symmetric containment geometry for containing a plasma at its center, such electrodes include a cooling structure or flow channel formed in the internal structure allowing for a cooling fluid for extracting heat caused by plasma and nuclear reactions;
b. electrical insulators preferably pure swept Quartz (SiO2) separating the electrodes and an outer end thereof; and
c. a protective, continuously changing protective film or layer of high electro-conductive fissile or fertile material such as thorium carbide or uranium carbide in which Lithium may be added for the reactor to breed its own Tritium, applied to the surfaces adjacent the acceleration channel formed between two electrodes.

2. A laser assisted fusion reactor comprising pulsed plasma generators for generating a plasma sheath, the reactor comprising:
a. elongated triangular electrodes aligned in a cylindrical shape to form a plurality of plasma generators or acceleration channels, such electrodes being separated by mean of pure and transparent swept quartz and having a cooling flow channel formed therethrough; wherein the electrodes are protected by mean of a continuously changing protective layer or film, the protective film constituting a fuel blanket where it contains fissile or fertile material such as Thorium or uranium. Lithium may be added for the fusion reactor to breed its own Tritium, said protective film being made by ceramic powder metallurgy process; and
b. a laser disposed in axial alignment with each acceleration channel, wherein the laser is synchronized to fire on the current sheath as it propagates between the electrodes of the acceleration channels, and wherein the laser beam is focused onto propagating plasma sheath; wherein further, the laser having triggering means connected thereto whereby said laser will produce its laser beam at the time the plasma sheath is generated between the electrodes of the fusion reactor.
